(19) United States
(12) Patent Application Publication
(10) Pub. No.: US 2019/0239691 A1
(43) Pub. Date: Aug. 8, 2019

(54) THERMOS WITH DUAL FUNCTIONING LID AND BASE

(71) Applicant: BLACK RIFLE COFFEE COMPANY LLC, Salt Lake City, UT (US)

(72) Inventors: Jeffrey B. Kirkham, Draper, UT (US); Evan Hafer, Salt Lake City, UT (US); Haase Robert Andreas, Kamas, UT (US)

(21) Appl. No.: 16/262,731

(22) Filed: Jan. 30, 2019

Related U.S. Application Data
(60) Provisional application No. 62/625,698, filed on Feb. 2, 2018.

(51) Int. Cl. A47J 41/02; B65D 21/02; B65D 43/02; B65D 51/24

(52) U.S. Cl. CPC A47J 41/02; B65D 21/0233; B65D 51/249; B65D 51/242; B65D 43/0229

(57) ABSTRACT

An improved thermos is provided. This improved thermos includes an outer thermos and a nestable inner thermos which is structured so as to be nestable within the outer thermos. The thermos includes a lid that is structured to seal the nestable inner thermos and a dual functioning base which is configured in size and shape for physically operating as both (1) a base for the thermos when the dual functioning base is positioned on a bottom portion of the thermos with a friction fit, and (2) a lid for the outer thermos when the dual functioning base is positioned on a top portion of the outer thermos with a friction fit.

### CROSS-REFERENCE TO RELATED APPLICATIONS

This application claims priority to U.S. Provisional Application Ser. No. 62/625,698, filed on Feb. 2, 2018 and entitled “IMPROVED THERMOS WITH DUAL FUNCTIONING LID AND BASE,” the entirety of which is incorporated herein by reference.

### BACKGROUND

Liquid containers are used in a variety of settings and environments. Although the use of nestable liquid containers is generally known, such containers fail to satisfy all of the current needs of the users of those containers. Indeed, many of the current nestable containers fail to properly latch on to one another. As a result, when used in a rugged environment, the nestable containers work themselves loose from one another and fail to perform as desired. Additionally, many of the current nestable containers fail to include integrated lids for each of the containers. As a result, the practical use of all of the nestable containers is quite limited because only a single container may be sealed while the other containers are left open. Accordingly, there is a need for a better nestable liquid container design.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include an improved thermos. In some embodiments, a thermos includes an outer thermos and a nestable inner thermos which is structured so as to be nestable within the outer thermos. The thermos includes a lid that is structured to seal the nestable inner thermos and a dual functioning base which is configured in size and shape for physically operating as both (1) a base for the thermos when the dual functioning base is positioned on a bottom portion of the thermos with a friction fit, and (2) a lid for the outer thermos when the dual functioning base is positioned on a top portion of the outer thermos with a friction fit.

Some disclosed embodiments include methods for assembling an improved thermos. In some embodiments, a method for assembling an improved thermos includes obtaining a nestable inner thermos which is structured so as to be nestable within an outer thermos and positioning the nestable inner thermos such that the nestable inner thermos is nested within the outer thermos. The method further includes securing a lid to the nestable inner thermos to seal the nestable inner thermos and securing a dual functioning base to a bottom portion of the outer thermos. The dual functioning base is configured in size and shape for physically operating as both (1) a base for the thermos when the dual functioning base is positioned on the bottom portion of the outer thermos, and (2) a lid for the outer thermos when the dual functioning base is positioned on a top portion of the outer thermos.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a profile view of an example thermos with a lid and a dual functioning base.

FIG. 2 illustrates a top-angle inclined view of an example thermos.

FIG. 3 illustrates a top view of an example thermos.

FIG. 4 illustrates an example thermos where the lid and the dual functioning base have been removed.

FIG. 5 illustrates various nesting features of an example thermos.

FIG. 6 illustrates an exploded view of an example thermos where an inner nestable thermos has been removed from within the outer thermos and the lid and the dual functioning base have been removed.

FIG. 7 illustrates another exploded view of an example thermos where the inner nestable thermos is viewed on its side while the outer thermos is viewed from a top view.

FIG. 8 illustrates another exploded view of an example thermos where both the inner nestable thermos and the outer thermos are viewed from a top angled view.

FIG. 9 illustrates a top view of the outer thermos.

FIG. 10 illustrates a top view of the inner nestable thermos.

FIG. 11 illustrates a profile view of the outer thermos where the dual functioning base has been removed.

FIG. 12 illustrates additional details of the dual functioning base.

FIG. 13 illustrates the dual functioning base mounted on a bottom portion of the outer thermos to thereby act as a base for the outer thermos.

FIG. 14 illustrates the dual functioning base mounted on a top portion of the outer thermos to thereby act as a lid for the outer thermos.

FIG. 15 illustrates a profile view of the outer thermos where the dual functioning base is acting as a lid.

FIG. 16 illustrates profile views of both the inner nestable thermos and the outer thermos where the inner nested thermos is covered with a lid and the outer thermos is covered with the dual functioning base.

FIG. 17 illustrates another view of the example thermos.

FIG. 18 illustrates a flowchart of an example method for using an improved thermos that includes a dual functioning base.

### DETAILED DESCRIPTION

Disclosed embodiments are directed to a thermos with a lid and a dual functioning base. In particular, the thermos includes an outer thermos and a nestable inner thermos. The nestable inner thermos is structured so that it is nestable within the outer thermos. The thermos also includes a lid that is structured to seal the nestable inner thermos. Additionally, the thermos includes a dual functioning base. This dual functioning base is structured so that it can act as either (1) a base for the thermos when the dual functioning base is positioned on a bottom portion of the thermos or (2) a lid for the outer thermos when the dual functioning base is positioned on a top portion of the outer thermos.

### Thermos with a Dual Functioning Base

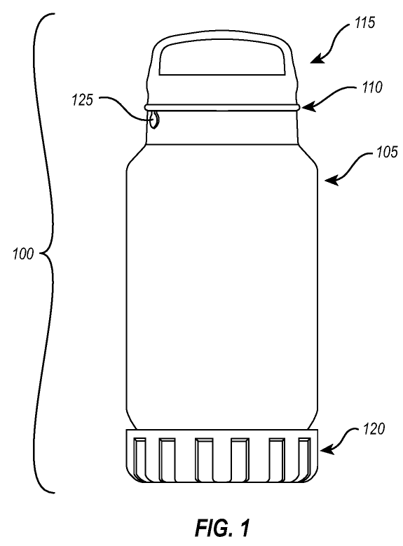

Referring to FIG. 1, a thermos 100 is presented. This thermos 100 is comprised of an outer thermos 105 and a nestable inner thermos 110. As shown in FIG. 1, the nestable inner thermos 110 is currently nested within (i.e. fitted inside) the outer thermos 105 such that only a lip portion (where the arrow corresponding to the nestable inner thermos 110 is pointing) of the inner thermos 110 is visible. The thermos 100 also includes a lid 115 and a dual functioning base 120. Additional details on this dual functioning base 120 will be discussed later. As also illustrated in FIG. 1, the outer thermos 105 additionally includes a latching mechanism 125. This latching mechanism 125 is structured so as to secure the nestable inner thermos 110 to the outer thermos 105 when the inner nestable thermos 110 is nested inside the outer thermos 105. Although not visible in FIG. 1, the inner nestable thermos 110 includes a corresponding latching mechanism. Here, the lid 115 is being used to seal the nestable inner thermos 110.

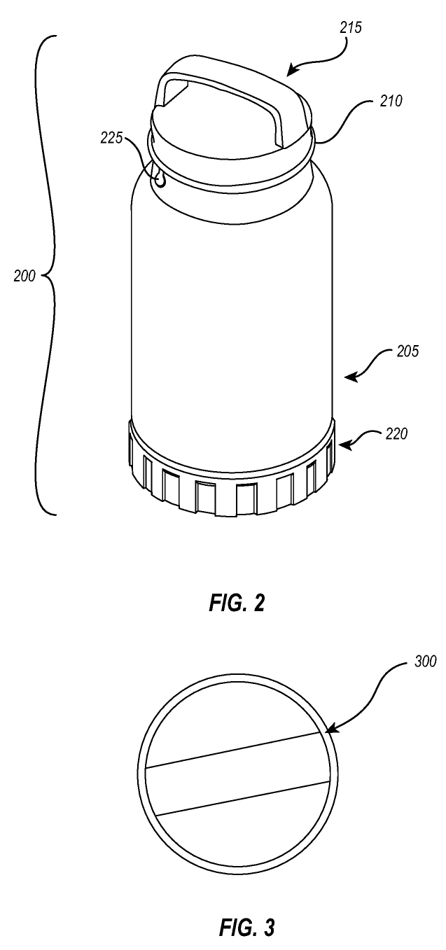

FIG. 2 illustrates a thermos 200 that is analogous to the thermos 100 of FIG. 1. Here, thermos 200 is visualized from a top-angle inclined view. Thermos 200 also includes an outer thermos 205, a nestable inner thermos 210 (where only a lip portion is currently visible), a lid 215, a dual functioning base 220, and a latching mechanism 225.

FIG. 3 illustrates a top view of the thermos 200 of FIG. 2. From this top view, only the lid 300 is clearly viewable.

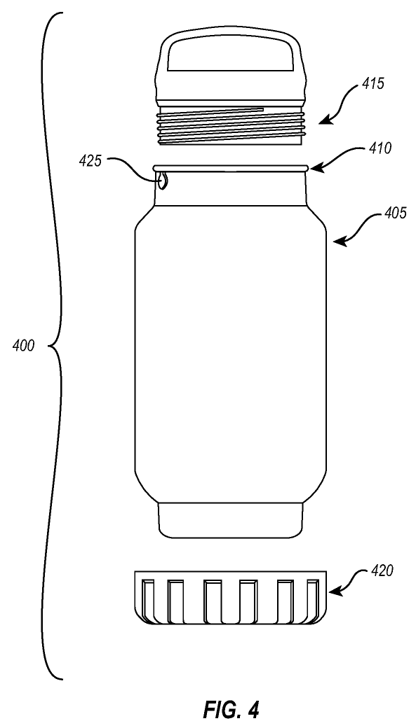

FIG. 4 illustrates an exploded view of the thermos 400, which is analogous to the thermos 100 of FIG. 1 and thermos 200 of FIG. 2. Here, thermos 400 includes an outer thermos 405, an inner thermos 410 (where only a lip portion is visible), a lid 415, a dual functioning base 420, and a latching mechanism 425.

It is worthwhile to reflect on the shape of the outer thermos 405. With the dual functioning base 420 removed from the bottom portion of the outer thermos 405, it is apparent that the outer thermos 405 is narrower at its upper and bottom portions. This particular design is beneficial because it more fully secures the nestable inner thermos 410 when positioned within the outer thermos 405. To clarify, due to the structure of the nestable inner thermos 410, when the nestable inner thermos 410 is nested inside of the outer thermos 405, both a top portion of the nestable inner thermos 410 and a bottom portion of the nestable inner thermos 410 are secured by the narrower upper and bottom portions of the outer thermos 405. This securing functionality will become more apparent in later Figures when the nestable inner thermos 410 is removed from within the outer thermos 405.

Additionally, the dual functioning base 420 is structured so as to securely fit on the narrower bottom portion of the outer thermos 405. When the dual functioning base 420 is thusly situated, the dual functioning base 420 serves as a base portion for the thermos 400. Similar to the earlier Figures, the lid 415 is structured so as to fit, or rather cover, the nestable inner thermos 410. When the nestable inner thermos 410 is removed from within the outer thermos 405, the dual functioning base 420 is now able to serve as a lid for the outer thermos 405 while the lid 415 can continue to operate as the lid for the inner thermos 410. As a result, both the nestable inner thermos 410 and the outer thermos 405 have a corresponding lid, which lids are able to retain any liquids that are inside either the nestable inner thermos 410 or the outer thermos 405. Accordingly, it will be appreciated that the dual functioning base 420 may serve as either a base for the outer thermos 405 or as a lid for the outer thermos 405. In some embodiments, the dual functioning base 420 is structured to form a friction fit with the narrower bottom portion of the outer thermos 405 and with the narrower top portion of the outer thermos 405.

Those skilled in the art will appreciate that the dual functioning base 420 is not limited to the structure illustrated in FIG. 4. For example, in some embodiments, both the narrower bottom portion and the narrower top portion of the outer thermos 405 include respective threaded portions, and the dual functioning base 420 includes complementary threading to enable the dual functioning base 420 to screw onto the narrower bottom portion and the narrower top portion of the outer thermos 405. In some embodiments, the outer thermos 405 is a straight cylinder thermos without a narrower top portion and/or a narrower bottom portion. In some embodiments, the outer thermos 405 includes only a narrower top portion or, alternatively, only a narrower bottom portion. In some embodiments, the top and/or bottom portions flare outward or inward a determined amount.

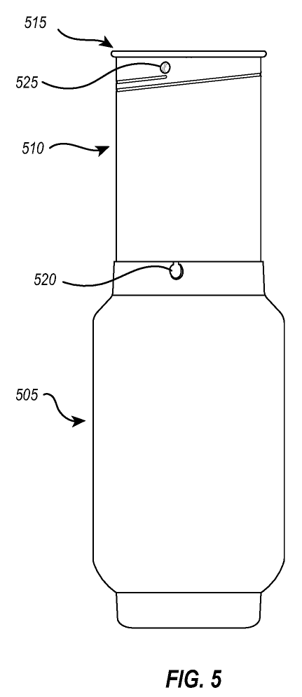

Turning now to FIG. 5, FIG. 5 shows the outer thermos 505 and the nestable inner thermos 510. In this scenario, the nestable inner thermos 510 has been partially removed from its nested position within the outer thermos 505. A lip portion 515 of the nestable inner thermos 510 is also viewable. In the previous figures, this lip portion 515 was the only viewable portion of the nestable inner thermos 510. This lip portion 515 provides a grip for the user when separating the nestable inner thermos 510 from the outer thermos 505. Some embodiments, however, do not include this lip portion 515.

With the nestable inner thermos 510 now partially removed from its nested position, additional portions of the nestable inner thermos 510 are now viewable. Here, the latching mechanism 520 of the outer thermos 505 is viewable. Additionally, a corresponding latching mechanism 525 on the nestable inner thermos is also viewable. When the nestable inner thermos 510 is fully nested within the outer thermos 505, the latching mechanism 525 is secured, or rather “latched,” to the latching mechanism 520.

It will be appreciated that different latching mechanism types may be used. For instance, in FIG. 5, the latching mechanism 520 is structured as a protruding portion that protrudes outwardly from the outer thermos 505. The latching mechanism 525 is also a protruding portion. When the nestable inner thermos 510 is nested within the outer thermos 505, the protruding portion of the latching mechanism 525 fits within the protruding portion of the latching mechanism 520.

Other types of latching mechanisms may be used. For example, instead of outwardly protruding portions for the latching mechanisms 520 and 525, some embodiments are structured to include an inwardly protruding portion for the latching mechanisms 520 and 525. Similarly, some embodiments have screw-tight latching mechanisms such that the nestable inner thermos 510 screws into the outer thermos 505. Additionally, some embodiments utilize latch clasps for the latching mechanisms. Furthermore, in some embodiments, the latching mechanisms of the inner thermos and the outer thermos include complementary magnetic elements for securing the inner thermos to the outer thermos in a desired position. In another example, the latching mechanisms include complementary channels (e.g., elongated channels, protruding inward or outward, extending around the upper portions of the inner thermos and the outer thermos), which are configured to fit within one another to secure the inner thermos to the outer thermos. From this disclosure, it will be appreciated that any type of latching mechanism may be used to secure the nestable inner thermos 510 to the outer thermos 505 when the nestable inner thermos 510 is nested within the outer thermos 505. Accordingly, the embodiments should not be limited simply to that which is portrayed in the current Figures.

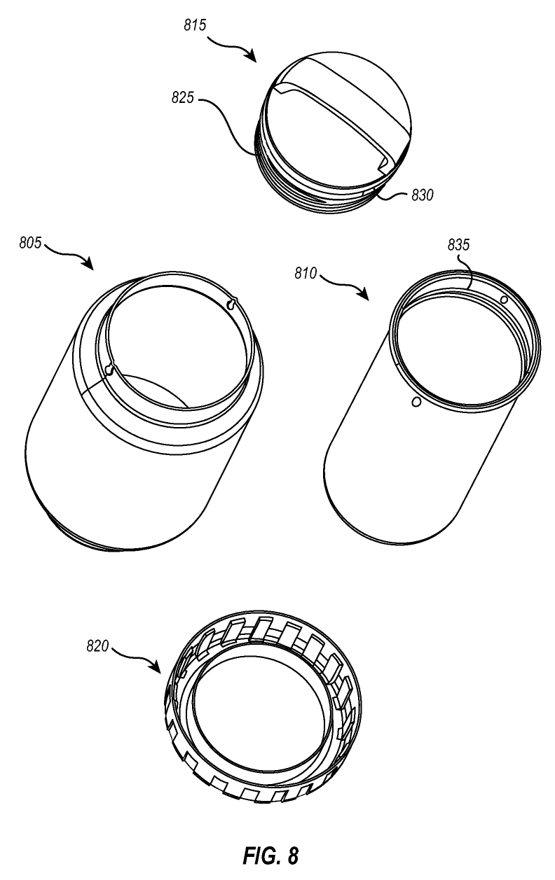

In some embodiments, the inner thermos 510 includes two or more latching mechanisms 525, and the outer thermos 505 includes two or more corresponding latching mechanisms 520 (as is more readily apparent on inner thermos 810 and outer thermos 805 of FIG. 8). Those skilled in the art will appreciate that the inner thermos and the outer thermos may include any number of corresponding latching mechanisms (e.g., 1, 2, 3, 4, 5, or more latching mechanisms).

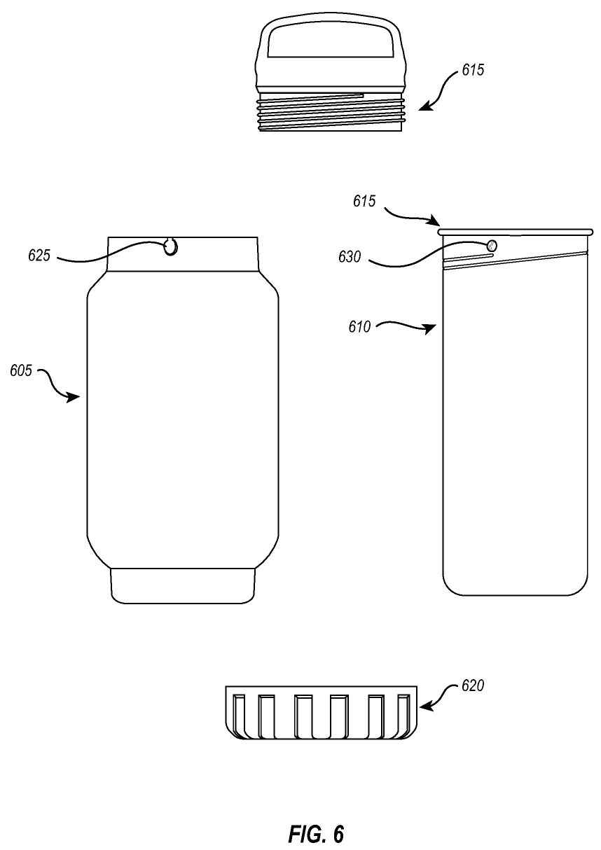

FIG. 6 illustrates another exploded view of a thermos. As illustrated, there is an outer thermos 605, which is an example implementation of the outer thermos 505 of FIG. 5, and a nestable inner thermos 610, which is an example implementation of the nestable inner thermos 510 of FIG. 5. Also shown is a lid 615, which is structured so as to close off the nestable inner thermos 610, and a dual functioning base 620. The dual functioning base 620 is structured so that it can either serve as a base to the outer thermos 605 or as a lid to the outer thermos 605. Additional details on this functionality will be discussed later.

As shown in FIG. 6, the outer thermos 605 is narrower at its top and bottom portions. Relatedly, the nestable inner thermos 610 is structured as a long cylinder. Of note, the diameter of the nestable inner thermos 610 is designed so that the nestable inner thermos 610 is able to be nested within the outer thermos 605. Additionally, the diameter of the narrower top and bottom portions of the outer thermos 605 are designed so that when the nestable inner thermos 610 is nested within the outer thermos 605, the outer portions of the nestable inner thermos 610 contact the inner portions of the narrower top and bottom portions of the outer thermos 605. In other words, the nestable inner thermos 610 (when nested within the outer thermos 605) is secured within the outer thermos 605 not only by a latching mechanism 625 on the outer thermos 605 and a corresponding latching mechanism 630 on the nestable inner thermos 610, but the nestable inner thermos 610 is also secured in place by the narrower top and bottom portions of the outer thermos 605. As a result, the nestable inner thermos 610 is prevented from rattling or otherwise moving while nested within the outer thermos 605. FIG. 6 also shows how the inner thermos 610 includes a lip 635, which can be used by a user to pull apart the two thermoses when they are in a nested state.

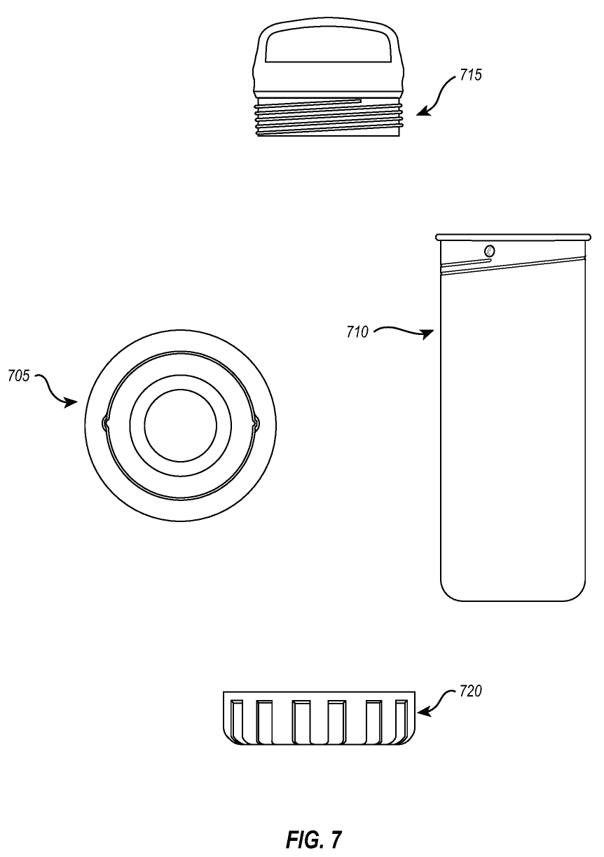

FIG. 7 shows another view of an outer thermos 705, a nestable inner thermos 710, a lid 715, and a dual functioning base 720. Here, the outer thermos 705 is positioned in an upright manner while the nestable inner thermos 710 is positioned on its side. Furthermore, the lid 715 is shown as being a type of screw-on lid. In other embodiments, however, the lid 715 may be a press-fit or friction fit lid.

FIG. 8 presents a similar scenario in which an outer thermos 805, a nestable inner thermos 810, a lid 815, and a dual functioning base 820 are displayed. Here, however, both the outer thermos 805 and the nestable inner thermos 810 are now positioned in an upright manner.

Additional focus will now be directed to the lid 815. As illustrated, the lid 815 includes a threaded portion 825 and a rubber gasket 830. The threaded portion 825 is able to screw into a corresponding threaded portion 835 on the nestable inner thermos 810. As a result, the lid 815 may be securely screwed onto the nestable inner thermos 810. When the lid 815 is thusly disposed, any substance within the nestable inner thermos 810 is prevented from leaking out of the nestable inner thermos 810. The rubber gasket 830 provides an additional seal so as to prevent substances from leaking out of the nestable inner thermos 810. It will be appreciated that while FIG. 8 illustrates the lid 815 as having the threaded portion 825 and the rubber gasket 830, other embodiments are structured in a different manner. Indeed, some embodiments do not include the rubber gasket 830. Some embodiments include a latch clasp as opposed to the threaded portion 825. Accordingly, from this disclosure, it will be appreciated that the lid 815 may include any suitable structure so that the lid 815 is able to be secured to the nestable inner thermos 810 and is able to retain substances within the nestable inner thermos 810. Similarly, when the dual functioning base 820 operates as a lid for the outer thermos 805, the dual functioning base 820 may be screwed on to the opened top portion of the outer thermos 805, it may be force fit onto the top portion, or it may be latch clasped onto the top portion. In this regard, the dual functioning base 820 is also structured to seal the top portion of the outer thermos 805. Additionally, in some embodiments, the dual functioning base 820 includes its own corresponding rubber gasket.

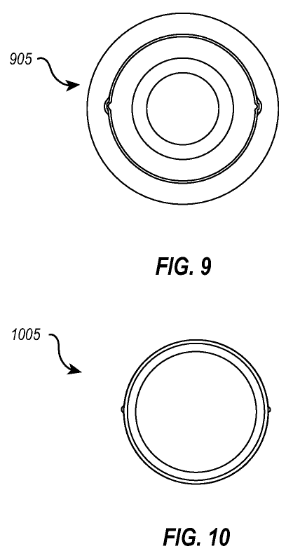

FIG. 9 illustrates a top view of the outer thermos 905, which is an example implementation of the outer thermos 805 of FIG. 8. FIG. 9 specifically shows how the outer thermos 905 flares outward in its middle portion.

Relatedly, FIG. 10 illustrates a top view of the nestable inner thermos 1005, which is an example implementation of the nestable inner thermos 810 of FIG. 8. In contrast to the middle flaring of outer thermos 905 of FIG. 9, the inner thermos 1005 does not flare outward in its middle elongated section.

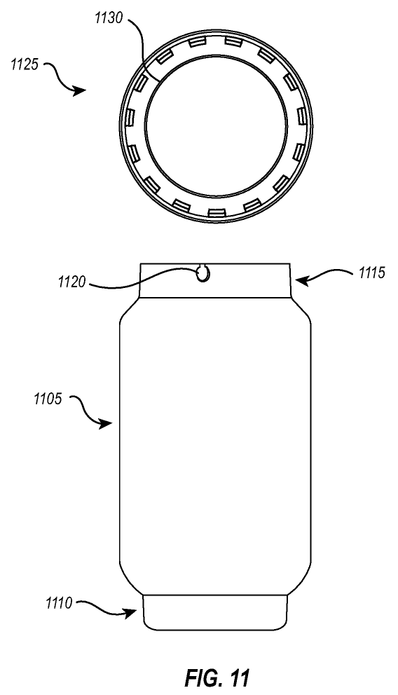

FIG. 11 illustrates the outer thermos 1105 having a narrower bottom portion 1110 and a narrower top portion 1115. Disposed on the narrower top portion 1115 is a latching mechanism 1120. Although not shown in FIG. 11, there is a corresponding latching mechanism on the nestable inner thermos. FIG. 11 also shows a dual functioning base 1125. This dual functioning base 1125 includes an inner securing member 1130 used to seal the dual functioning base 1125 to either the narrower top portion 1115 or the narrower bottom portion 1110.

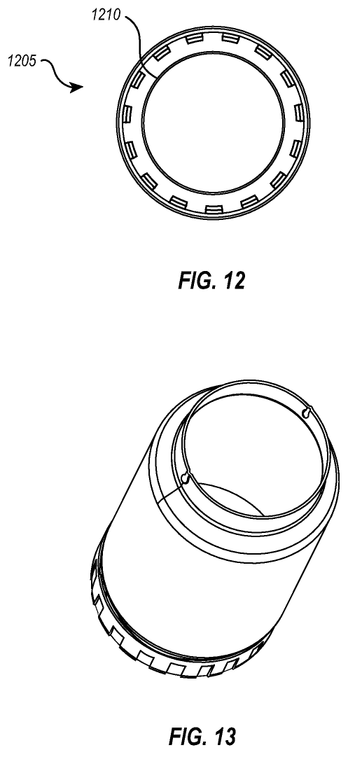

As illustrated in FIG. 11, the diameter of the narrower bottom portion 1110 is substantially similar to the diameter of the narrower top portion 1115. When the dual functioning base 1125 is positioned, clasped, sealed, or otherwise affixed to the narrower bottom portion 1110 (so that it is acting as a base to the outer thermos 1105), the securing member 1130 securely fits to the narrower bottom portion 1110. Relatedly, when the dual functioning base 1125 acts as a lid to the outer thermos 1105, the securing member 1130 securely fits, clasps, seals, or otherwise affixes to the narrower top portion 1115. When thusly positioned, the dual functioning base 1125 is able to prevent any substance (e.g., liquid or solid) located within the outer thermos 1105 from leaking out. Additional details on the dual functioning base 1125 are presented in FIG. 12.

FIG. 12 illustrates a dual functioning base 1205, which is an example implementation of the dual functioning base 1125 of FIG. 11. Here, this dual functioning base 1205 also includes a securing member 1210, which is representative of the securing member 1130 of FIG. 11. From this disclosure, it will be appreciated that the diameter of the securing member 1210 is designed so that the dual functioning base 1205 is able to securely fit onto the narrower top and bottom portions of the outer thermos (e.g., narrower top portion 1115 and narrower bottom portion 1110 of FIG. 11). In some embodiments, the securing member 1210 is or includes a rubber gasket seal.

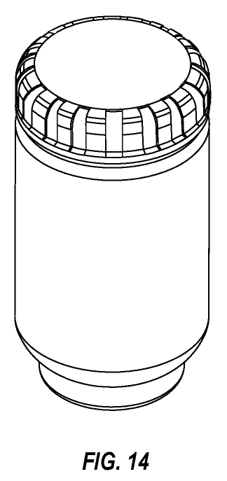

FIG. 13 illustrates a scenario where the dual functioning base is securely positioned to the narrower bottom portion of the outer thermos. When thusly positioned, the dual functioning base acts as a base to the outer thermos. Similarly, FIG. 14 illustrates a scenario where the dual functioning base is securely positioned to the narrower top portion of the outer thermos. When thusly positioned, the dual functioning base acts as a lid to the outer thermos. In this regard, it is noted that, in some embodiments, the base/lid forms a friction fit with the top of the outer container and the base of the outer container, as shown in FIGS. 13 and 14.

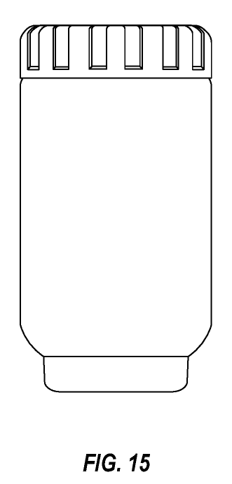

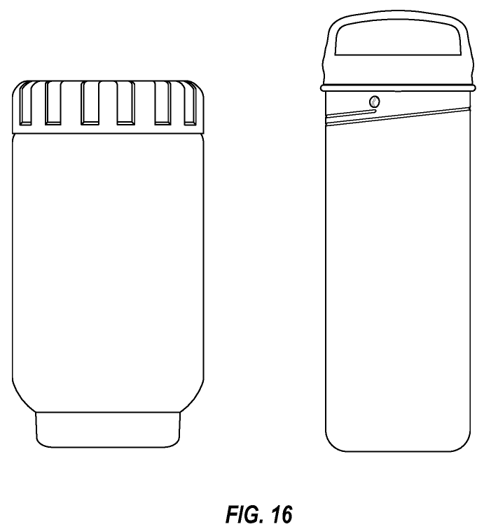

FIG. 15 illustrates a profile view of the outer thermos where the dual functioning lid is securely mounted on the narrower top portion of the outer thermos. In this position, the dual functioning base is acting as a lid for the outer thermos.

FIG. 16 illustrates profile views of both the outer thermos and the nestable inner thermos. Here, the dual functioning base is securely mounted to the narrower top portion of the outer thermos such that it is acting as a lid for the outer thermos. Relatedly, a lid is also securely mounted to the nestable inner thermos. As a result, both the outer thermos and the nestable inner thermos are able to be securely covered with a lid.

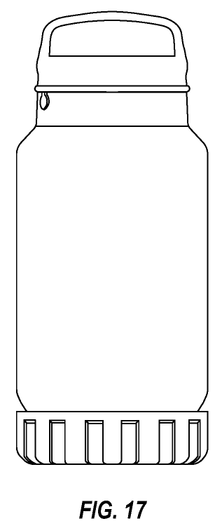

Finally, FIG. 17 illustrates the same thermos that was presented in FIG. 1. Here, it will be appreciated that the disclosed embodiments relate to an improved thermos design. In particular, an outer thermos and a nestable inner thermos are presented. The nestable inner thermos is able to be securely nested within the outer thermos. Indeed, the nestable inner thermos is secured not only by a latching mechanism, but also by a narrower top and bottom portion of the outer thermos. As a result of the combination of the latching mechanism and the narrower top and bottom portions of the outer thermos, the nestable inner thermos is prevented from becoming dislodged or rattling. Additionally, the thermos includes a lid that may be securely mounted to the nestable inner thermos. The thermos also includes a dual functioning base. When securely positioned on the bottom portion of the outer thermos, the dual functioning base acts as a base. In situations where the nestable inner thermos is removed, then the dual functioning base may then act as a lid for the outer thermos. Accordingly, the dual functioning base is structured to perform multiple different functionalities.

The disclosed embodiments may, in some instances, provide various advantages over conventional liquid containers. Some of these advantages include providing users with nestable thermoses which latch to one another in a secure manner and which include integrated lids for sealing each of the nestable thermoses.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

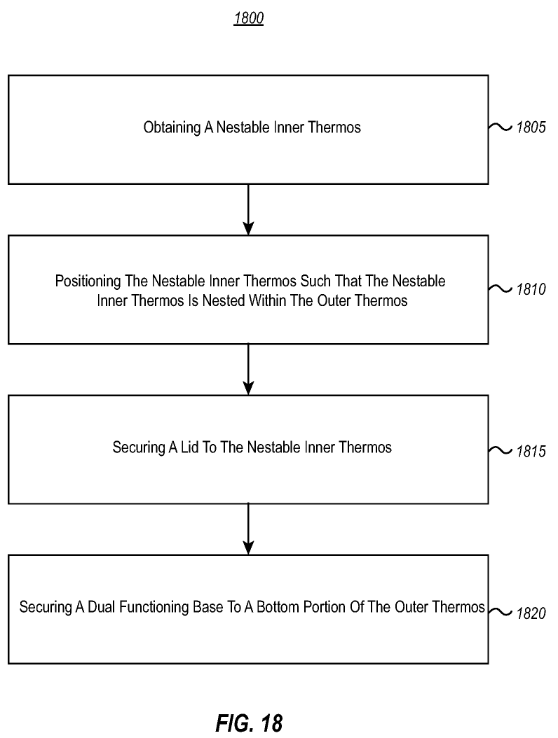

In particular, FIG. 18 illustrates a flowchart of an example method 1800 for assembling a thermos (e.g., a thermos as shown and described in relation to FIGS. 1-17). Method 1800 includes an act 1805 of obtaining a nestable inner thermos. The nestable inner thermos, in some embodiments, corresponds to the nestable inner thermos 510 described hereinabove, and is structured so as to be nestable within an outer thermos (e.g., outer thermos 505 as illustrated in FIG. 5). Method 1800 further includes an act 1810 of positioning the nestable inner thermos such that the nestable inner thermos is nested within the outer thermos. In some embodiments, positioning the nestable inner thermos within the outer thermos includes latching one or more latching mechanisms of the outer thermos to one or more corresponding latching mechanisms of the nestable inner thermos (e.g., latching mechanisms 525 and 520, as described hereinabove with reference to FIG. 5) such that the position of the nestable inner thermos within the outer thermos is secured by the latching mechanisms. Furthermore, in some embodiments, the nestable inner thermos is held in place by positioning the nestable inner thermos within the outer thermos such that at least a part of the exterior of the nestable inner thermos contacts and becomes secured in place by the interior of narrower top and bottom portions of the outer thermos (as described hereinabove with reference to FIG. 6).

Additionally, method 1800 includes an act 1815 of securing a lid to the nestable inner thermos. The lid, in some embodiments, corresponds to lid 815 of FIG. 8, and may include a threaded portion 825 and a rubber gasket 830. The threaded portion 825 is able to screw into a corresponding threaded portion 835 on the nestable inner thermos. As a result, the lid 815 may be securely screwed onto the nestable inner thermos. When the lid 815 is thusly disposed, any substance within the nestable inner thermos is prevented from leaking out of the nestable inner thermos. The rubber gasket 830 provides an additional seal so as to prevent substances from leaking out of the nestable inner thermos.

Lastly, method 1800 includes securing (act 1820) a dual functioning base to the bottom portion of the outer thermos. The dual functioning base is configured in size and shape, in some embodiments, for physically operating as both a base for the thermos when the dual functioning base is positioned on the bottom portion of the outer thermos, and a lid for the outer thermos when the dual functioning base is positioned on the top portion of the outer thermos.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A thermos comprising:
an outer thermos;
a nestable inner thermos, the nestable inner thermos being structured so as to be nestable within the outer thermos;
a lid that is structured to seal the nestable inner thermos; and
a dual functioning base, the dual functioning base being configured in size and shape for physically operating as both (1) a base for the thermos when the dual functioning base is positioned on a bottom portion of the thermos with a friction fit, and (2) a lid for the outer thermos when the dual functioning base is positioned on a top portion of the outer thermos with a friction fit.

2. The thermos of claim 1, wherein the top portion of the outer thermos and the bottom portion of the outer thermos are narrower than a middle portion of the outer thermos, and wherein the nestable inner thermos is structured to contact an interior of the top portion and an interior of the bottom portion when the nestable inner thermos is nested within the outer thermos.

3. The thermos of claim 1, wherein the outer thermos includes a latching mechanism and the nestable inner thermos includes a corresponding latching mechanism, and wherein the latching mechanism and the corresponding latching mechanism are structured to latch together to secure the nestable inner thermos within the outer thermos when the nestable inner thermos is fully nested within the outer thermos.

4. The thermos of claim 3, wherein the latching mechanism of the outer thermos is a protruding portion that protrudes outwardly from the outer thermos, and wherein the corresponding latching mechanism of the nestable inner thermos is a corresponding protruding portion that protrudes outwardly from the nestable inner thermos.

5. The thermos of claim 3, wherein the outer thermos includes two latching mechanisms on opposing sides of the outer thermos, and wherein the nestable inner thermos includes two corresponding latching mechanisms that are on opposing sides of the nestable inner thermos and that align with the two latching mechanisms on the opposing sides of the outer thermos.

6. The thermos of claim 1, wherein the lid includes a threaded portion and a rubber gasket for sealing the nestable inner thermos when the lid is screwed onto the nestable inner thermos.

7. A method for assembling a thermos having a dual functioning base, the method comprising:
obtaining a nestable inner thermos, wherein the nestable inner thermos is structured so as to be nestable within an outer thermos;
positioning the nestable inner thermos such that the nestable inner thermos is nested within the outer thermos;
securing a lid to the nestable inner thermos, wherein the lid is structured to seal the nestable inner thermos; and
securing a dual functioning base to a bottom portion of the outer thermos, wherein the dual functioning base is configured in size and shape for physically operating as both (1) a base for the thermos when the dual functioning base is positioned on the bottom portion of the outer thermos, and (2) a lid for the outer thermos when the dual functioning base is positioned on a top portion of the outer thermos.

8. The method of claim 7, wherein positioning the nestable inner thermos such that the nestable inner thermos is nested within the outer thermos includes latching one or more latching mechanisms of the outer thermos to one or more corresponding latching mechanisms of the nestable inner thermos, such that the nestable inner thermos is secured within the outer thermos by the one or more latching mechanisms and the one or more corresponding latching mechanisms.

9. The method of claim 8, wherein the one or more latching mechanisms of the outer thermos are protruding portions that protrude outwardly from the outer thermos, and wherein the one or more corresponding latching mechanisms of the nestable inner thermos are corresponding protruding portions that protrude outwardly from the nestable inner thermos.

10. The method of claim 9, wherein the outer thermos includes two latching mechanisms on opposing sides of the outer thermos, and wherein the nestable inner thermos includes two corresponding latching mechanisms on opposing sides of the nestable inner thermos.

11. The method of claim 7, wherein positioning the nestable inner thermos such that the nestable inner thermos is nested within the outer thermos includes positioning the nestable inner thermos such that at least a part of an exterior portion of the nestable inner thermos contacts and becomes secured in place by an interior of a narrower top portion and an interior of a narrower bottom portion of the outer thermos.

12. The method of claim 7, wherein the lid includes a threaded portion and a rubber gasket for sealing the nestable inner thermos when the lid is screwed onto the nestable inner thermos.
